(19) United States
(12) Patent Application Publication
(10) Pub. No.: US 2007/0011637 A1
(43) Pub. Date: Jan. 11, 2007

(54) Method and system for performing local geometrical operation on a hierarchical layout of a semiconductor device

(76) Inventors: Alexander Seidl, Muenchen (DE); Dirk Meyer, Essex (GB)

Correspondence Address: SLATER & MATSIL LLP, 17950 PRESTON ROAD, SUITE 1000, DALLAS, TX, 75252, US

(21) Appl. No.: 11/448,169

(22) Filed: Jun. 6, 2006

(30) Foreign Application Priority Data
Jun. 6, 2005 (DE) 102005026935.4-53

(51) Int. Cl. G06F 17/50

(52) U.S. Cl. 716/9

(57) ABSTRACT

At least one cell pair graph is generated for cells of the layout. A partial inverse layout tree is determined from the cell pair graph. For the partial inverse layout tree, only branches of the complete inverse layout tree are considered that describe an interaction between shapes of different cells. A data set is generated from the partial inverse layout tree and the data set is saved, for example, by using the partial inverse layout tree.

This application claims priority to German Patent Application 10 2005 026 935.4-53 which was filed Jun. 6, 2005 and is incorporated herein by reference.

### TECHNICAL FIELD

The present invention relates generally to semiconductor devices, and in a particular embodiment to a method and system for performing local geometrical operation on a hierarchical layout of a semiconductor device.

### BACKGROUND

For the design of an integrated circuit or a structure in semiconductor technology (generally termed “layout”) the verification of each element within a layout against design rules is of great importance. The design rules define the conditions that are, for example, necessary for a successful manufacturing of semiconductor devices. Basic definitions of the terms used in the following description are, for example, found in U.S. Pat. No. 5,528,508, which is incorporated herein by reference.

In the layout of integrated circuits or the layout of other structures of semiconductor devices the design rule checks (DRC) or similar operations can be divided into two classes:

1. Local operations: The results can be computed by taking local interactions between shapes into account. Shapes in this context are understood to be geometric forms representing structures or a part of a structure in the layout. Shapes in particular can be geometric primitives such as boxes, wires or polygons.

A local interaction here means that the interaction is limited by the range (distance). Examples of such local operations are: Geometric operations as Boolean Operators (AND, ANDNOT, XOR), spacing checks and distance checks or the placing of elements for an Optical Proximity Correction (OPC). An example for a spacing check would be, for example, that a rule requires that the space between two metal edges is not below a certain value; otherwise a short circuit might occur.

2. Non-local Operations: The results can be computed by taking into account closed regions (also termed as groups) of interacting shapes. The determination of the area of hierarchically distributed mask polygons is an example for such a non-local operation.

Layout data for a design is commonly structured in a hierarchy of cells since such a structure in general is computationally easier to handle than a flat structure. Each cell in this context may contain shapes, i.e., geometric forms forming the structure of the actual layout, or other cells referred to as subcells or child cells. The cell containing the subcell is then also referred to as parent cell to the subcell.

One cell may occur several times in a layout, the occurrences of the cell in the layout being referred to as instances of the cell.

In a flat design rule checking tool, each subcell of a layout is replaced by a copy of the referenced cell to produce a flat layout containing only shapes, i.e., geometric forms. The resulting data structure is large and, therefore, can be handled only in a computationally expensive manner.

A hierarchical design rule checking tool on the other hand performs the design rule check directly on the hierarchical data structure of the layout. This allows a computationally efficient handling, but design rule check tools are more complicated to implement.

Hierarchical, physical verification tools of layouts (e.g., Assura by Cadence and Calibre by Mentor Graphics) differ in their computational time, the data volume for intermediate results and end results and in the representation of the results in the cell hierarchy. This influences the assessment of the results by the layout designers. The methods used for the processing of the hierarchy herein have a decisive influence on the mentioned aspects, i.e., the computation time and the data volume to be kept in storage.

An inefficient hierarchy processing may, for example, lead to longer design times for a DRC in the layout design or for simulation based OPC.

From the following references, each of which is incorporated herein by reference, it is known to use methods involving “Inverse Layout Trees” (ILT) to collect and process the hierarchical shape and cell interactions for a layout and to represent the results in a layout hierarchy:

Hedenstiema, Jeppson, “The use of inverse layout trees of hierarchial design rule checking,” 26th ACM/IEEE Design Automation Conference, 1989.

Hedenstiema, Jeppson, “The use of inverse layout trees for hierarchical design verification,” Proceedings of ICCAD-88, Santa Clara, pp. 534-537, November 1988.

Hedenstiema, Jeppson, “The Halo Algorithm—An algorithm for hierarchical design rule checking of VLSI circuits,” IEEE Transactions of Computer Aided Design of Integrated Circuits and System, Vol. 12, No. 2, February 1993.

U.S. Pat. No. 5,528,508 discloses a method that additionally uses a counter for instances for that purpose.

U.S. Pat. No. 5,559,718 describes a method in which a processing unit is coupled to a verification database. The result register has an input and an output, whereby the input of the result register is coupled to the output of a processing unit. The processing unit can override individual results.

### SUMMARY OF THE INVENTION

In various aspects, the current invention is concerned with a method and a system in which layout data for local operations can be efficiently processed in a hierarchical way.

In a first embodiment, generating at least one cell pair graph is generated for cells of the layout. A partial inverse layout tree is determined from the cell pair graph. For the partial inverse layout tree, only branches of the complete inverse layout tree are considered that describe an interaction between shapes of different cells. A data set is generated from the partial inverse layout tree and the data set is saved, for example, by using the partial inverse layout tree.

Embodiments of the invention have the advantage that an inverse layout tree is generated only partially using a cell pair graph, whereas the respective complete inverse layout tree does not need to be computed at any instance in time. The cell pair graph herein is used to filter out branches of the inverse layout tree that do not contain interactions between shapes of interacting cells. By filtering out such branches, a considerable reduction in computation time can be achieved.

The cell pair graph herein encodes the interactions between different cells and their shapes in a compact, hierarchical manner. By using such a cell pair graph, thus, the interactions between shapes of different cells can be determined efficiently, reducing the computational effort to a minimum. The structure of the partial inverse layout tree results from superimposing information that is extracted from the cell pair graph and information about the relation between the cells extracted from the conventional (non inverse) layout graph.

In comparison to conventional design rule checking methods, the method according to the invention does not use explicit and complete inverse layout trees to encode shape interactions between cells, but rather extracts the information from a cell pair graph, a cell pair of two interacting cells being examined for interactions between the corresponding shapes contained in the cells on the fly when generating the partial inverse layout tree.

The shape interactions for all cell pairs that contain a particular cell referred to as base cell, are in an embodiment of the invention determined prior to the computation of the partial inverse layout tree and can then be referenced for all instances of the cell pair in the inverse layout tree. In another advantageous embodiment, only such cell pairs are considered for generating the partial inverse layout tree for which interactions of a given base shape with an intruder shape occur (if not all possible base shapes of the cell are treated in a single inverse layout tree).

The method according to the invention does not require instance counters to determine whether a component exists on a hierarchical level or not.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a schematic drawing of a cell pair graph;

FIG. 2 is a schematic drawing of interactions between cells of a layout;

FIG. 3 is a drawing of a layout tree for the layout according to FIG. 2;

FIG. 4 is a cell pair graph corresponding to the layout according to FIG. 2;

FIGS. 5 to 11 are schematic drawings illustrating the steps for stepping through a partial inverse layout tree;

FIG. 12 is an overview showing the flow diagram of an embodiment of the method according to the invention;

FIG. 13 is a flow diagram illustrating the computation of interacting cell-subcell pairs;

FIG. 14 is a flow diagram illustrating the computation of interacting subcell pairs;

FIG. 15 is a flow diagram illustrating the stepping through a partial inverse layout tree; and

FIG. 16 is a flow diagram illustrating the computation and the output for the method according to FIG. 15.

### DETAILED DESCRIPTION OF ILLUSTRATIVE EMBODIMENTS

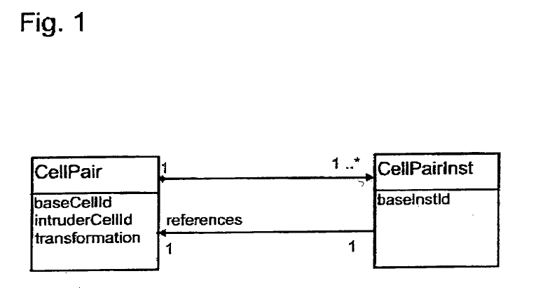

FIG. 1 shows a cell pair graph with a first node 11 and a second node 12, the arrows 20 forming the edges of the graph.

Within the design of a layout, the cell pair graph serves to efficiently encode and store interactions between cells of the layout. The data structure used for the cell pair graph herein is produced by determining interacting cells and storing such cells together with hierarchy information.

Within the scope of the invention, two cells forming a cell pair are considered interacting if an interaction occurs between shapes of the cells or subcells of the cells.

The first node 11 of a cell pair graph according to FIG. 1 forms a data set called “CellPair” which denotes a cell pair of interacting cells and contains a field for an identifier of a base cell called “baseCellId” and a field for an identifier of an intruding cell (also referred to as intruder cell) called “intruderCellId”. Furthermore, the node CellPair contains a field “transform” indicating a transformation defining the relative position of the cell instances with respect to each other.

A base cell is a cell containing one or more base shapes (or containing subcells that contain one or more base cells). Analogously, an intruder cell is a cell containing one or more intruding shapes (or its subcells containing one or more intruder cells). A cell in this context is “intruding” a base cell if it is interacting with the base cell, i.e., a shape of the cell interacts with a shape of the base cell.

The distinction between base cells and intruder cells is mainly a question of definition. Within the course of the process, each cell is considered and, when considered, defined as a base cell. The intruding cells for this considered base cell are then the intruder cells.

The second node 12 in FIG. 1 forms a data set “CellPairInst” describing the instance of the base cell of the interacting cell pair. The node CellPairInst contains a field “baseInstId” representing an identifier for the base cell instance of the cell pair. The node CellPairInst, thus, indicates which instance of the base cell interacts with the intruder cell, i.e., for which instance of the base cell the cell pair interaction defined in the node CellPair occurs.

The association “references” denoting an interaction 20 (edge of the graph) points to a referenced cell pair. The arrows indicate the direction of the association. The indices refer to the multiplicity of the association, i.e., 1 cell pair references 1 . . . * instances of cell pairs. Commonly, for this purpose a UML notation is used.

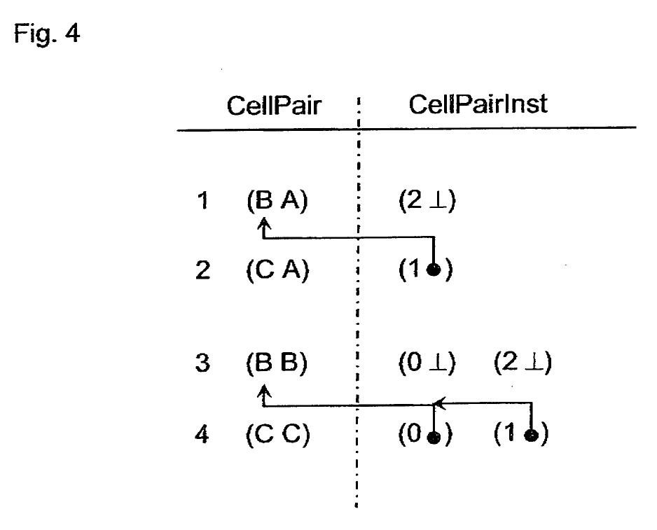

The base cell of the referenced cell pair with its identifier baseCellId herein is a parent cell of the base cell of the referencing cell pair. Analogously, the intruder cell with its identifier intruderCellId is a parent cell of the intruder cell of the referencing cell pair. This is explained in detail below in connection with FIG. 4.

Alternatively, it is also possible for the base cell (intruder cell) to be equal to the base cell (intruder cell) of the referencing cell pair.

With this structure, interactions between parent cells and child cells (i.e., cells on different hierarchy levels) as well as between sibling cells (i.e., cells on the same hierarchy level) can be described.

Within the cell pair graph, cell pairs are stored in terms of a table to facilitate the search for a particular cell pair. The table is used to identify interactions between cell pairs and their dependent cell pairs that have been computed previously and thus do not need to be computed again. In this way, redundant computations can be avoided. Furthermore, the table can be used to find all cell pairs that have a common base cell.

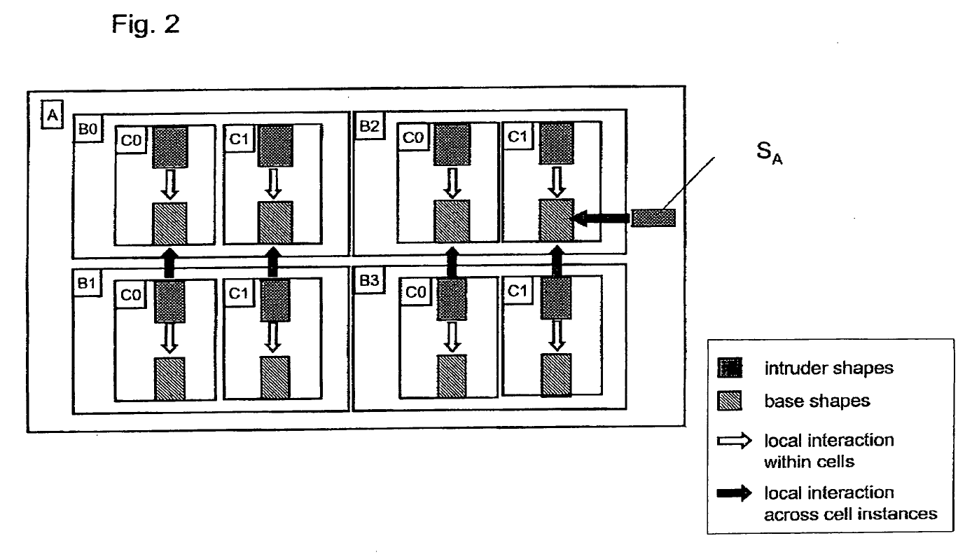

In FIGS. 2 to 11 the method according to the invention is explained in detail with reference to a specific example of a layout containing a number of cells.

The method for processing the example herein can be divided in two parts: generation of the cell pair graph describing the layout structure; and stepping through a partial inverse layout tree for base cells or base shapes, the partial inverse layout tree being extracted from the cell pair graph.

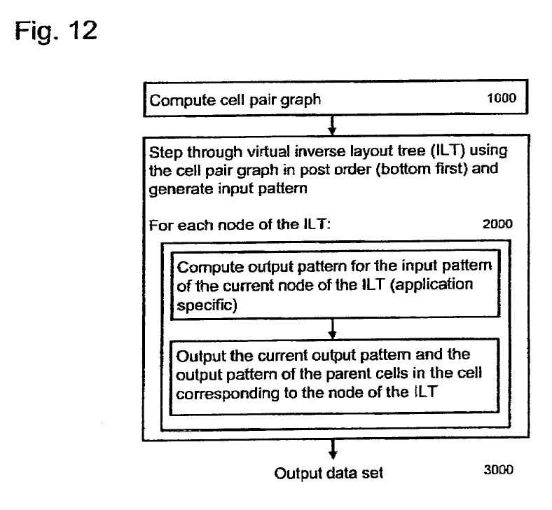

FIG. 12 shows a flow diagram of a method for performing local geometrical operation on a hierarchical layout, comprising steps 1000, 2000 and 3000. Step 1000 herein represents the computation of the cell pair graph; step 2000 represents the computation of and stepping through the partial inverse layout tree; and step 3000 represents the generation of an output data set that can be further processed for the purpose of design rule checking of a layout.

First, the generation of the cell pair graph is explained in the following with respect to the drawings of FIGS. 2 to 4.

The cell pair graph is generated by determining all hierarchical interactions between two cells forming a cell pair, wherein the cell pair graph is determined in a top-down approach starting with the cells on the highest hierarchy level and stepping down to the lowest hierarchy level. For the cell pair graph, when considering a cell, all interactions that are encountered for the first time (i.e., the interaction has not been encountered previously for other cells) are determined. The generation of the cell pair graph is performed for all cells of the layout in arbitrary order, in each case starting from a high level in hierarchy and stepping down to the lowest level.

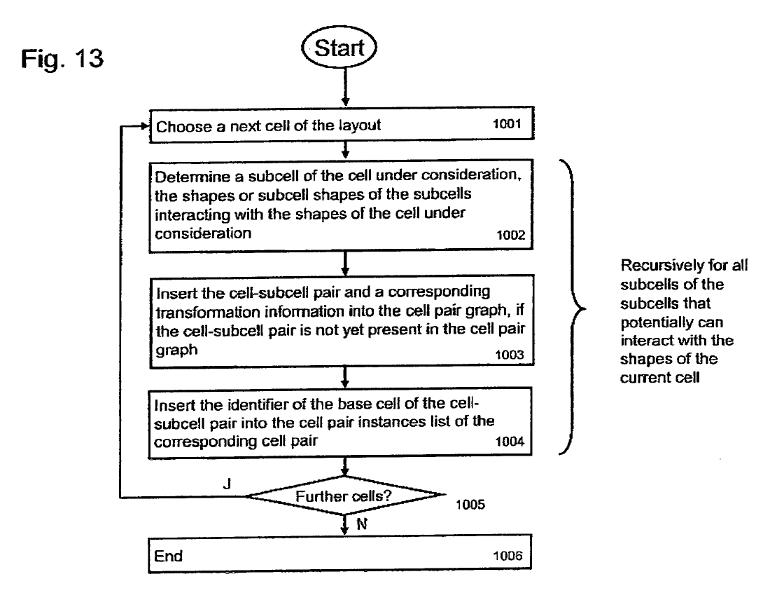

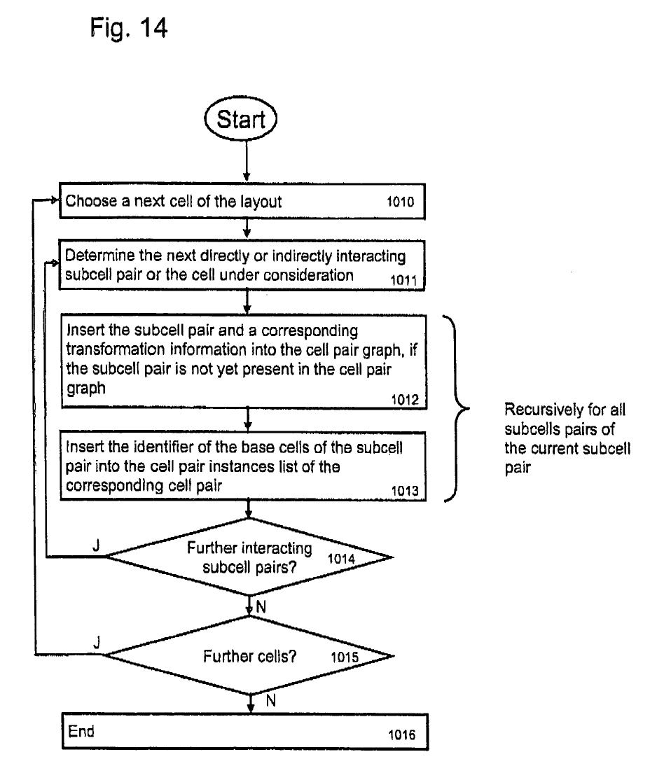

The method for generating the cell pair graph can be divided in two parts which are illustrated in the flow diagrams of FIGS. 13 and 14.

In the first part (see FIG. 13), the interaction between parent cells and child cells, i.e., the interactions between cells across levels of the hierarchical data structure, are determined, a parent cell on a higher hierarchy level being the intruder cell and a child cell on a lower hierarchy level being the base cell. The child cell herein can be a direct or indirect subcell of the parent cell, i.e., the parent cell and the child cell may differ by one or more hierarchy levels. To determine the parent-child cell interactions, all cell-subcell pairs are examined recursively, wherein the identifier baseInstId of each base cell (representing a child cell) is taken directly from the layout hierarchy.

In the second part (see FIG. 14), the interaction between sibling cells, i.e., cells on the same hierarchy level, are determined, wherein one cell is the intruder cell and the other the base cell. Contrary to the interactions between parent and child cells, the sibling interactions are caused by the instantiation of the sibling cells in a mutual (direct or indirect) parent cell. For this purpose, all direct subcell pairs of a cell and the subcell pairs of the subcell pairs are examined recursively.

FIG. 2 shows an example of a layout with interactions between two layers of the layout. Within a design rule check, for example the distance between the two layers is to be checked. For the purpose of a design rule check, the method according to the invention may for example be used for a distance or spacing check between the geometric shapes of the cells and may be used for layouts with one or multiple layers.

FIG. 2 shows schematically a layout containing three cells A, B and C.

Cell A encompasses four instances of cell B, i.e. instances B1, B2, B3, B4; cell B again encompasses two instances of cell C, i.e., instances C0 and C1. The filled black arrows (e.g., between instance B2 of cell B and the shape SA of cell A) represent an interaction between parent and child cells and their shapes across different hierarchy levels, whereas the framed white arrows represent interactions between sibling cells or sibling shapes on the same hierarchy level, the sibling cells being instances of a common parent cell and the sibling shapes being part of the same cell.

Base shapes in FIG. 2 are represented by a single line filling, whereas intruder shapes are represented by a crossed line filling.

The number of the instances of the cells represent their identifier. Thus, instance B0 of cell B is a base cell (because it contains a base shape) and its identifier baseCellId is 0.

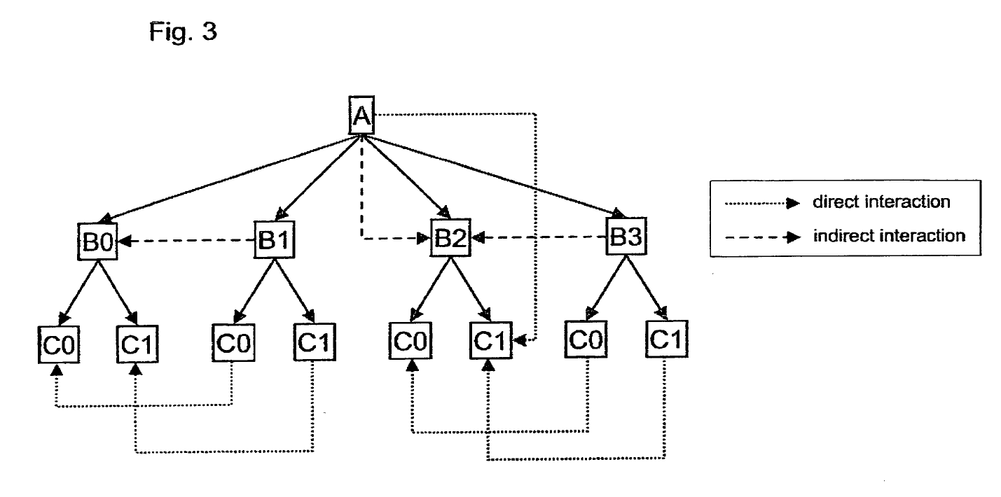

FIG. 3 shows the layout tree representing the layout according to FIG. 2. A direct interaction, i.e., a direct interaction between shapes of two cells, between different cells on the same or on different hierarchical layers herein is represented by a dotted arrow, whereas an indirect interaction, i.e., an interaction between cells containing subcells with interacting shapes that mediate the interaction, is indicated by a dashed arrow.

FIG. 4 shows the corresponding cell pair graph for the example according to FIGS. 2 and 3.

The cell pair graph encodes the interactions between the cells of the hierarchical layout in an efficient and easy to interpret manner. In the left column of the cell pair graph the interacting cell pairs are listed, each interacting cell pair being represented by a bracketed term in the left column in FIG. 4. Herein, the first cell listed in each bracketed term represents the base cell identified by its identifier baseCellId, whereas the second cell represents the intruder cell identified by its identifier intruderCellId (see FIG. 1). Thus, in line 1 denoting the interaction between cell B and cell A, cell B (being the child cell) is the base cell because it carries the base shape and cell A (being the parent cell) is the intruder cell because it carries the intruder shape (see FIG. 2).

In the right column, the instance of the base cell of the layout interacting with the intruder cell is given. The instance of the intruder cell herein is not listed explicitly, but rather is described by a relative transformation between the base cell and the intruder cell that is stored together with the cell pair in the data set CellPair (see FIG. 1). The transformation herein defines the relative position of the intruder cell with respect to the base cell. Thus, knowing the identifier baseCellId of the base cell, the identifier intruderCellId of the intruder cell and the relative transformation between the two, the instance of the intruder cell can be derived from the instance of the base cell.

If the interaction of a cell pair indirectly mediates an interaction of another cell pair, e.g., because a cell is instantiated as a subcell within a parent cell, this is indicated in the cell pair graph by a pointer between the instance of the cell and the parent cell. In the example of FIGS. 2 to 4, instance 1 of cell C interacts with cell A (see FIG. 2 and line 2 of FIG. 4) and at the same time is instantiated in cell B, so that also cell B interacts with cell A (see FIG. 2 and line 1 of FIG. 4). This dependency is indicated in the cell pair graph of FIG. 4 by the pointer between line 2 and line 1 pointing from the right column entry in line 2 (indicating instance 1 of cell C) to the left column entry (indicating cell B) in line 1 of the cell pair graph. Such pointers represent associations according to arrows 20 in FIG. 1. If no associations are present, no pointer is provided, indicated in the right column of FIG. 4 by the symbol ⊥.

How the cell pair graph is generated from the layout according to FIG. 2 shall be explained in detail below.

In an embodiment of the invention, in addition, a data set is stored to describe the relative position of the cells with respect to each other (not shown herein).

In the exemplary layout according to FIG. 2, four interacting cell pairs are presented, namely cell pairs (B A), (C A), (B B) and (C C) listed in the cell pair graph according to FIG. 4. The first two lines describe parent-child interactions (between the child cells B and C and their respective parent cell A), whereas the third and fourth lines describe sibling interactions (between the instances of cell B and the instances of cell C as indicated in FIG. 2 and FIG. 3).

The references to a cell pair indicated by the pointers in FIG. 4 associating the dependent cells (e.g., cells B and C indicated by the pointer between lines 4 and 3) may be expanded. Since each interaction between instances of cell C (line 4) mediates an indirect interaction between two instances of B (line 3) and since there are two interactions between instances of cell C and two interactions between instances of cell B (indicated by the instance entries (0) (2) in line 3 and (0) (1) in line 4), line 4 of the cell pair graph effectively describes four interactions between different instances of cell C.

In a corresponding complete inverse layout tree, six branches would be necessary to encode the same amount of information, because eight instances of cell C in cell A require (see FIG. 2) seven nodes and six branches in an inverse layout tree. If all interactions visible at a particular node of the layout were to be stored in a complete inverse layout tree, the information contained in the cell pair graph would have to be stored for each node.

The main advantage of using a cell pair graph lies in the fact that by using the cell pair graph the interaction between cell pairs does not have to be computed twice. Rather, the interaction for a particular cell pair is computed only once and then referenced if a second identical cell pair is encountered.

This can be illustrated by considering FIG. 4. For storing the four interactions between the eight instances of cell C, four instances in the right hand column in lines 3 and 4 are required. If an additional instance of a (B B) cell pair was present, only another instance would have to added in the right hand column in line 3, thus minimizing the computational effort and optimizing the storage space required for storing the interaction between cell pairs and subcell pairs. The advantageous efficiency becomes more and more pronounced with growing length of the instantiation paths and increasing numbers of cell instances.

FIGS. 13 and 14 show two submethods for the generation of the cell pair graph. Both submethods together constitute step 1000 according to FIG. 12, wherein the submethods according to FIGS. 13 and 14 can be performed in arbitrary order to generate the cell pair graph from an existing layout.

FIG. 13 shows a first submethod comprising steps 1001 to 1006 for computing interacting cell-subcell pairs for the purpose of generating the cell pair graph.

FIG. 14 shows a second submethod comprising steps 1010 to 1016 for computing the interactions between subcells, i.e., child cells, of a cell.

Using the submethods according to FIGS. 13 and 14 the cell pair graph encoding the interactions between cell pairs of a layout is generated. This shall be explained in the following with reference to the layout according to FIG. 2 and the cell pair graph according to FIG. 4.

Referring now to FIG. 13, first in step 1001, a cell is chosen starting from the highest hierarchy level. With respect to the layout according to FIGS. 2 and 3 and starting on the highest hierarchy level, cell A is chosen first.

Next, in step 1002, those subcells, i.e., child cells, of the cell under consideration are determined whose shapes (directly or indirectly) interact with shapes of the chosen cell. Thus, with respect to FIGS. 2 and 3, first cell B is identified as a candidate because of the interaction of an instance of cell B with the only shape contained in A (see FIG. 2: shape SA on the very right of the layout contained only in cell A).

Then, in step 1003, the identified cell-subcell pair is inserted into the cell pair graph together with transformation information. Thus, the left-hand side entry (B A) of line 1 of the cell pair graph according to FIG. 4 is inserted. The first cell here is cell B, because the base shape is contained in cell B, whereas the intruder shape is part of cell A. The transformation of B in A is not shown in FIG. 4, but stored within the cell pair graph (see FIG. 1) in order to specify the relation between the corresponding cells.

Next, in step 1004, the instance identifier baseInstId of the base cell is inserted into the field CellPairInst of the corresponding entry in the cell pair graph. This creates the right-hand side entry of line 1 in the cell pair graph. The base cell here is cell B, because it carries the base shape. The instance of cell B that is relevant is instance 2 (see FIG. 2), because only instance 2 of cell B interacts with the shape S_{A} contained in cell A (see FIG. 2).

Next, steps 1002 to 1004 are recursively repeated for subcells of cells that interact with the current cell. For the layout according to FIG. 2, subcells of B are searched for. In this case, there is only one subcell C to cell B and it has a shape interacting with the shape of the current cell A. Applying steps 1002 to 1004 then renders line 2 of the cell pair graph according to FIG. 4. The instance of cell C (in cell B) that is relevant is instance 1. The cell pair of interacting cells is (C A). Cell C is entered first since the base shape is contained in cell C. The interaction of cell C with cell A indirectly mediates an interaction of cell B, instance 2, with cell A, because the base shape is contained in cell C and cell C is a subcell of cell B. This is indicated by the pointer from the instance of cell C to cell B pointing from the right-hand side entry of line 2 to the left-hand side entry of line 1 in the cell pair graph of FIG. 4.

In step 1005, finally, it is proceeded to the next cell of the layout. In this case, proceeding to cell B does not render new results, since cell B does not have any shapes of its own that could interact with any child cell, and cell C does not have child cells.

Referring now to FIG. 14, for determining the interacting subcell pairs, first in step 1010, a cell is chosen. With respect to the layout according to FIGS. 2 and 3 and starting on the highest hierarchy level, cell A is taken.

Next, in step 1011, the next pair of directly or indirectly interacting child cells of the current cell under consideration is chosen. In the case according to FIG. 2 there is only one child cell of cell A, namely cell B, with two cell pairs interacting, i.e., instance 0 with instance 1 of cell B and instance 2 with instance 3 of cell B. The interaction does not happen directly, but through child cells C of cell B.

In step 1012, the child cell pairs determined in step 1011 are inserted into the cell pair graph together with their transformation information. In this case, both interacting cell pairs have the same relative transformation (distance vector). The left-hand side of the cell pair graph denoting the two interacting cells and their relative transformation, thus, will get one new entry (B B) in line 3 of the cell pair graph (see FIG. 4).

In step 1013, the instance identifier baseInstId is inserted into the corresponding line of the cell pair graph. Here, two entries are created on the right-hand side: one for instance 0 (the first instance of the first interacting cell pair B0-B1) and one for instance 2 (the first instance of the second interacting cell pair B2-B3). The instance identifier of the second cell is described indirectly by the relative transformation and is not noted in the cell pair graph according to FIG. 4.

Next, steps 1011 to 1013 are recursively repeated for sub cell pairs of the current cell pair. This applies to the two instances of cell C (instance 0 and instance 1) interacting with the same instances of cell C from another instance of cell B. Repeating steps 1011 to 1013 for the interacting cells C renders line 4 of the cell pair graph. Two new interactions are created between instances 0 and 0 of cell C and instances 1 and 1 of cell C. Again, the second interacting instance identifier is not noted in the cell pair graph according to FIG. 4. Each (C C) interaction again mediates the same indirect interaction between two instances of cell B. Since there are two (B B) interactions (indicated by the two instance identifiers on the right hand side of line 3 in the cell pair graph according to FIG. 4), line 4 of the cell pair graph effectively describes four interactions between different instances of cell C.

Next, in step 1014, it is examined whether any more interacting child cells are present. Since in this case there are no more interacting child cells of cell A, it is proceeded with step 1010.

Proceeding with step 1010, cell B is chosen as the next cell and does not yield new interactions, since the two instances of cell C in cell B (considering cell B by itself) do not interact. Further, taking cell C does not generate new interactions either, since cell C does not have child cells (see FIG. 2).

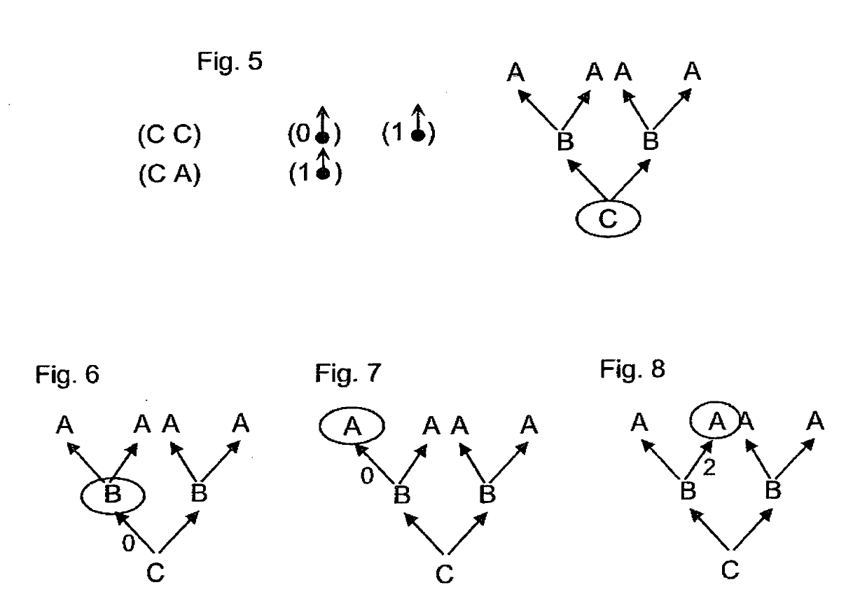

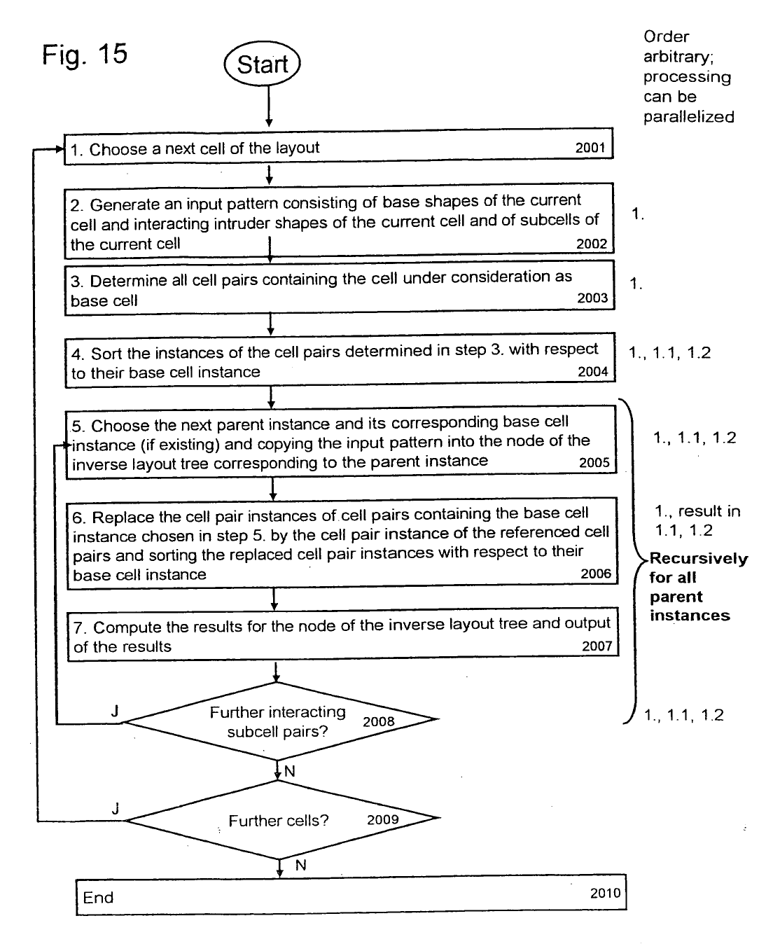

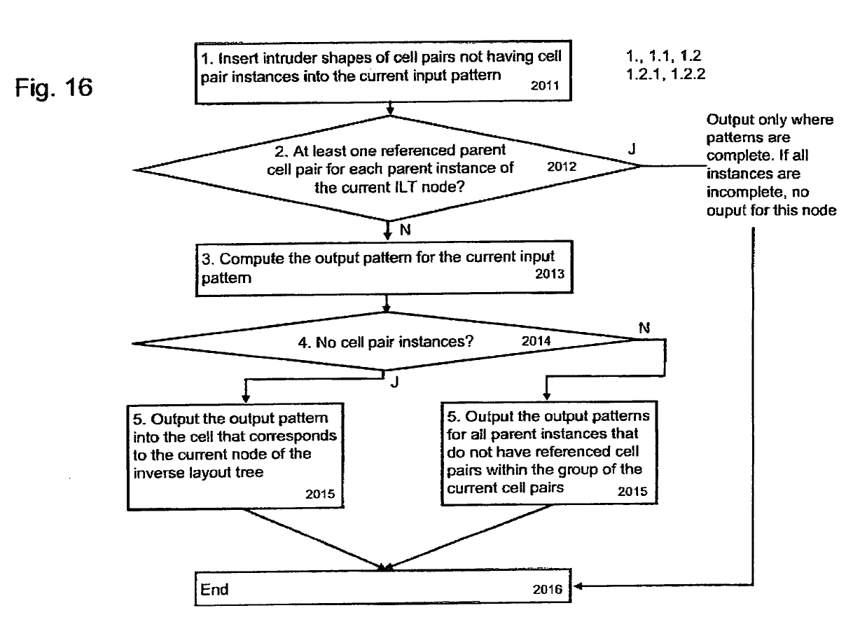

Next, the stepping through a partial inverse layout tree for the purpose of applying local operations to the cells of a layout, for example for design rule checking, using a cell pair graph that encodes the interaction information of all interacting cell pairs of a layout shall be explained with reference to FIGS. 5 to 11 and the flow diagrams of FIGS. 15 and 16.

In the embodiment described in the following, environments of shapes are examined with respect to their interactions with neighboring shapes. The interacting shapes generally form patterns referred to as input pattern, which occur repeatedly in a layout and consist of base shapes and intruder shapes. The computations of the corresponding output patterns herein are application specific, as well as the definition of the intruder shapes that are considered for computing a pattern.

The method according to the invention is used for applying local hierarchical operations to a layout. Such operations for example may be sizing operations or Boolean operations. Thus, accordingly the output pattern herein is defined as the pattern that results from applying a local operation to a corresponding input pattern. The output pattern thus constitutes the result of the local operation applied to an input pattern.

Within the method, interactions between different cells, which are stored in the cell pair graph, are reduced to interactions between base shapes and intruder shapes. The steps required to compute such interactions are explained below.

In principal, the steps represent a stepping through an inverse layout tree starting from the bottom, i.e., the lowest hierarchy level.

For this, only such nodes (representing instances of cells) of the (complete) inverse layout tree (describing the complete layout) are considered, which are necessary for the computation of the interactions. This means that not necessarily all instances of base cells must be considered, such as it is done conventionally.

The expressions “parent” and “child” in the following are used to describe the hierarchal relation between the cells rather than denoting a specific node of the inverse layout tree.

The subsequent steps can be performed in an application specific manner for all cells of a layout (see FIGS. 15 and 16):

For all base shapes or group of base shapes of a cell under consideration, all cell pairs are sought whose base cell equals the cell under consideration (in an advantageous embodiment, only such cell pairs are sought that contain intruder shapes interacting with the base shape or group of base shapes).

The instances of the base cells, identified by their identifiers baseInstId, of each cell pair, identified in the cell pair graph in the field CellPairInst (see FIG. 1) on the right-hand side of the cell pair graph (see FIG. 4), are compared with the parent cell instances of the cell under consideration and are assigned to parent cell branches pointing from the instance of the cell under consideration to the parent cell instance in a virtual inverse layout tree.

If parent instances exist that do not have an associated instance of another cell pair, the input pattern of the node under consideration is assigned to these parent instances. If the cell under consideration does not have any instances CellPairInst in the cell pair graph, the node of the virtual inverse layout tree represents a leaf of the inverse layout tree.

The cell pair instances of each parent instance branch are replaced by the cell pair instances of such cell pairs that reference the parent instance (if the parent instance does not represent a leaf of the virtual inverse layout tree).

Input patterns are generated during the stepping through the virtual inverse layout tree by adding the intruder shapes for each parent instance. Whether all intruder shapes of a pair in the input pattern of the respective node of the inverse layout tree need to be considered, is dependent on a cell pair instance referencing a (parent) cell pair or not.

With respect to the stepping through the virtual inverse layout tree starting from the bottom (i.e., depth-first) shapes that do not occur in all output patterns of the parents of a node are output in the cells corresponding to the parent instances with their respective transformations. Shapes that occur in all parent instances are (recursively) output in the common “child” instance.

When using a partial inverse layout tree, only that portion of the inverse layout tree that is currently considered must be kept in storage.

By using such method, a number of advantages arise with respect to conventional methods for design rule checking: the cell pair graph stores interactions between cells in a very compact manner compared to the forest of inverse layout trees otherwise required; the computation of interactions of repeating cell pairs and their dependent subcell pairs needs to be performed only once, thus avoiding the repeated computation of identical cell pair interactions and reducing computation time; after determining the cell pair graph the partial inverse layout trees are generated, processed and computed independent from each other. This is advantageous for example for a parallelization of the computations; results are output on the lowest hierarchical level possible, due to the use of inverse layout trees; and as a consequence of the method, the layout can be split in separate small patterns (which may also overlap), for which the results can be stored in the memory (Cache) of the computing system. The repeated computation for equal patterns, thus, can be avoided. For typical layouts, the probability for repeating patterns herein is high, because a layout conventionally is composed of small patterns arranged repeatedly throughout the layout.

In the following, the above-summarized method for stepping through a layout is explained referring to FIGS. 5 to 11 and using the cell pair graph according to FIG. 4.

In FIGS. 5 to 11, the cell instance that is considered in each step is encircled. The arrows point from child cell instances to parent cell instances and represent branches of the partial inverse layout tree.

The root of the partial inverse layout tree is extracted from the cell pair graph. The input patterns to be considered contain the base shape of cell C and intruder shapes interacting with the base shape of cell C (see FIG. 5). Using the notation of the cell pair graph given in FIG. 4, then cell pair interactions (C C) and (C A) are considered, cell C in each case representing the base cell.

(FIG. 6) For parent instance 0 of cell C: The input patterns of 1. are not changed.

(FIG. 7) For parent instance 0 of cell B: The input patterns of 1. are used adding the intruder shapes of the (C C) cell pair.

(FIG. 8) For parent instance 2 of cell B: The input pattern of 1. is used adding the intruder shapes of the (C C) cell pair.

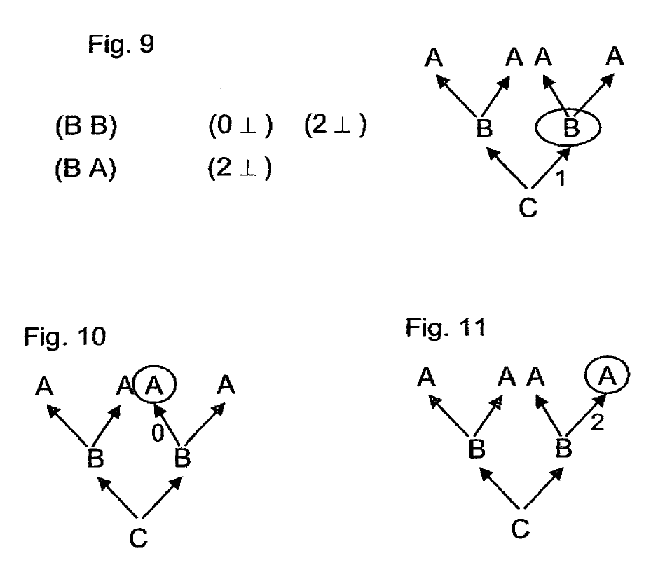

(FIG. 9) For parent instance 1 of cell C: The input pattern of 1. is not changed.

(FIG. 10) For parent instance 0 of cell B: The input pattern of 1. is used adding the intruder shapes of the (C C) cell pair.

(FIG. 11) For parent instance 2 of cell B: The input pattern of 1. is used adding the intruder shapes of the (C C) cell pair and the intruder shapes of the (C A) cell pair.

Thus, all branches of the partial inverse layout tree are processed.

In an advantageous embodiment all computations are performed in parallel, thus saving computation time. The method described herein is particularly suitable for parallelization, since, after the cell pair graph has been determined, all computations for each base shape can be performed independently.

An input pattern is defined by a specific pattern of interacting shapes of one or several cells. Referring to FIG. 2, a first input pattern for example consists of the base shape of an instance of cell C, the intruder shape of the same instance of cell C and the intruder shape of an adjacent instance of cell C. Note again that in FIG. 2 base shapes are indicated by a single line filling, whereas intruder shapes are indicated by C a crossed line filling. This input pattern occurs for seven of the eight instances of cell C in cell A. A second input pattern of the layout according to FIG. 2 contains additionally an intruder shape of cell A interacting with the base shape of cell C (see instance C1 in instance B2 in the upper right corner of the layout of FIG. 2).

The different input patterns can be determined using the cell pairs for a given base cell. The instantiations of the base cell then are determined during the stepping through the partial inverse layout tree.

The presented embodiment of the method generates input patterns from a list of interacting shapes (representing pattern components) during the process of the method. No preprocessing step is necessary in order to determine the relevant input patterns beforehand.

The pattern components, i.e., the components the input pattern consists of, are constituted by all interacting shapes, which are computed for each interacting cell pair containing a given base cell. The pattern components are grouped according to their occurrence in the inverse layout tree. This is achieved for a cell by expanding the list of cell pair instances of the cell pair graph in a depth-first run through all branches of a partial inverse layout tree containing the parent instances of the cell and the cell pair instances. All pattern components that are applied to the same group of parent instances are then grouped together.

FIG. 15 illustrates the stepping through the partial inverse layout tree in a flow diagram (steps 2001 to 2010). On the right-hand side of the flow diagram the steps are associated with the steps discussed above in reference to FIGS. 5 to 11.

FIG. 16 illustrates the computation and output of results for nodes in the partial inverse layout tree, explaining in detail step 2007 according to FIG. 15. Again, on the right-hand side of the flow diagram it is referred to the steps discussed in connection with FIGS. 5 to 11.

The method described herein can—rather than being applied to cells—also be applied to all base shapes or groups of base shapes. In an advantageous embodiment, shapes that occur in all parent instances of a cell under consideration, herein are output (recursively) in the common base cell.

The invention shall not be limited to the aforementioned exemplary embodiments. Rather, a number of variations are conceivable that use the method according to the invention although being implemented in a fundamentally different way.

What is claimed is:

1. A method for performing local geometrical operation on a hierarchical layout of a semiconductor device, the method comprising:
generating at least one cell pair graph for cells of the hierarchical layout;
determining a partial inverse layout tree from the at least one cell pair graph, wherein for the partial inverse layout tree only branches of a complete inverse layout tree are considered that describe an interaction between shapes of different cells; and
generating a data set from the partial inverse layout tree and saving of the data set.

2. The method according to claim 1, wherein generating and saving the data set comprises using the partial inverse layout tree.

3. The method according to claim 1, wherein the generating of the at least one cell pair graph includes determining interacting cell-subcell pairs, the determining comprising:
choosing a next cell of the hierarchical layout;
determining a subcell of the cell under consideration, shapes or subcell shapes of the subcells interacting with shapes of the cell under consideration;
inserting the cell-subcell pair and a corresponding transformation information into the at least one cell pair graph, if the cell-subcell pair is not yet present in the at least one cell pair graph;
inserting an identifier of a base cell of the cell-subcell pair into the at least one cell pair graph; and
recursively repeating determining a subcell, inserting the cell-subcell pair, and inserting the identifier for all subcells that possibly interact with the cell under consideration, until all subcells of the cell under consideration have been considered.

4. The method according to claim 1, wherein the determining of the at least one cell pair graph includes determining interacting subcell pairs, the determining comprising:
a) choosing a next cell of the layout;
b) determining the next directly or indirectly interacting subcell pair or the cell under consideration;
c) inserting the subcell pair and the corresponding transformation information into the at least one cell pair graph, if the subcell pair is not yet present in the at least one cell pair graph;
d) inserting the identifier of the base cell of the subcell pair into the at least one cell pair graph;
e) recursively repeating steps c) and d) for further subcell pairs of the subcell pair determined in step b);
f) repeating steps b) to e) for all interacting subcell pairs of the cell under consideration; and
g) repeating steps a) to f) for all cells of the hierarchical layout.

5. The method according to claim 2, wherein the partial inverse layout tree is stepped through for computing local interactions between cells of the hierarchical layout, the stepping through comprising the steps of:
a) choosing a next cell of the hierarchical layout;
b) generating an input pattern consisting of base shapes of the cell under consideration and interacting intruder shapes of the cell under consideration and of subcells of the cell under consideration;
c) determining all cell pairs containing the cell under consideration as base cell;
d) sorting the instances of the cell pairs determined in step c) with respect to their base cells;
e) choosing a next parent instance and its corresponding base cell instance (if existing) and copying the input pattern into a node of the inverse layout tree corresponding to the parent instance;
f) replacing the cell pair instances of cell pairs containing the base cell instance chosen in step e) by the cell pair instance of the referenced cell pairs and sorting the replaced cell pair instances with respect to their base cells;
g) computing the results for the node of the inverse layout tree and output of the results;
h) repeating steps e) to g) for all parent instances; and
i) repeating steps a) to g) for all cells.

6. The method according to claim 5, wherein the computing of the results for the node of the inverse layout tree and the output of the results comprises the steps of:
inserting intruder shapes of cell pairs not having cell pair instances into the current input pattern under consideration;
if at least one referenced parent cell pair exists for each parent instance of the current node of the inverse layout tree, output the results;
if no referenced parent cell pair exists, an output pattern is computed for the current input pattern;
if no cell pair instances exist, the output pattern is output into the cell that corresponds to the current node of the inverse layout tree;
if cell pair instances exist, the output patterns are output for all parent instances that do not have referenced cell pairs within a group of the current cell pairs.

7. A method of making a semiconductor device, the method comprising:
designing a layout for a semiconductor device, the designing comprising:
generating at least one cell pair graph for cells of the hierarchical layout;
determining a partial inverse layout tree from the at least one cell pair graph, wherein for the partial inverse layout tree only branches of a complete inverse layout tree are considered that describe an interaction between shapes of different cells;
generating a data set from the partial inverse layout tree and saving of the data set; and
fabricating the semiconductor device based upon the layout.

8. The method according to claim 7, wherein generating and saving the data set comprises using the partial inverse layout tree.

9. The method according to claim 7, wherein the generating of the at least one cell pair graph includes determining interacting cell-subcell pairs, the determining comprising:
choosing a next cell of the hierarchical layout;
determining a subcell of the cell under consideration, shapes or subcell shapes of the subcells interacting with shapes of the cell under consideration;
inserting the cell-subcell pair and a corresponding transformation information into the at least one cell pair graph, if the cell-subcell pair is not yet present in the at least one cell pair graph;
inserting an identifier of a base cell of the cell-subcell pair into the at least one cell pair graph; and
recursively repeating determining a subcell, inserting the cell-subcell pair, and inserting the identifier for all subcells that possibly interact with the cell under consideration, until all subcells of the cell under consideration have been considered.

10. The method according to claim 7, wherein the determining of the at least one cell pair graph includes determining interacting subcell pairs, the determining comprising:
a) choosing a next cell of the layout;
b) determining the next directly or indirectly interacting subcell pair or the cell under consideration;
c) inserting the subcell pair and the corresponding transformation information into the at least one cell pair graph, if the subcell pair is not yet present in the at least one cell pair graph;
d) inserting the identifier of the base cell of the subcell pair into the at least one cell pair graph;
e) recursively repeating steps c) and d) for further subcell pairs of the subcell pair determined in step b);
f) repeating steps b) to e) for all interacting subcell pairs of the cell under consideration; and
g) repeating steps a) to f) for all cells of the hierarchical layout.

11. The method according to claim 10, wherein the partial inverse layout tree is stepped through for computing local interactions between cells of the hierarchical layout, the stepping through comprising the steps of:
a) choosing a next cell of the hierarchical layout;
b) generating an input pattern consisting of base shapes of the cell under consideration and interacting intruder shapes of the cell under consideration and of subcells of the cell under consideration;
c) determining all cell pairs containing the cell under consideration as base cell;
d) sorting the instances of the cell pairs determined in step c) with respect to their base cells;
e) choosing a next parent instance and its corresponding base cell instance (if existing) and copying the input pattern into a node of the inverse layout tree corresponding to the parent instance;
f) replacing the cell pair instances of cell pairs containing the base cell instance chosen in step e) by the cell pair instance of the referenced cell pairs and sorting the replaced cell pair instances with respect to their base cells;
g) computing the results for the node of the inverse layout tree and output of the results;
h) repeating steps e) to g) for all parent instances; and
i) repeating steps a) to g) for all cells.

12. The method according to claim 11, wherein the computing of the results for the node of the inverse layout tree and the output of the results comprises the steps of:
inserting intruder shapes of cell pairs not having cell pair instances into the current input pattern under consideration;
if at least one referenced parent cell pair exists for each parent instance of the current node of the inverse layout tree, output the results;
if no referenced parent cell pair exists, an output pattern is computed for the current input pattern;
if no cell pair instances exist, the output pattern is output into the cell that corresponds to the current node of the inverse layout tree;
if cell pair instances exist, the output patterns are output for all parent instances that do not have referenced cell pairs within a group of the current cell pairs.

13. A system for performing local geometrical operation on a hierarchical layout of a semiconductor device, comprising:
means for generating at least one cell pair graph for cells of the layouts;
means for generating a partial inverse layout tree from the at least one cell pair graph, wherein for the partial inverse layout tree only branches of a complete inverse layout tree are considered that describe an interaction between shapes of different cells; and
means for generating an output data set using the partial inverse layout tree and storing a data set.
